(19) United States
(12) Patent Application Publication
(10) Pub. No.: US 2010/0224708 A1
(43) Pub. Date: Sep. 9, 2010

(54) SHOWER HEAD

(76) Inventor: Robert Boehnlein, Lewisburg, PA (US)

Correspondence Address: Charles L. Riddle, Esq., 434 Lackawanna Ave, Suite 200, Scranton, PA, 18503, US

(21) Appl. No.: 12/397,333

(22) Filed: Mar. 3, 2009

(51) Int. Cl. B05B 1/00

(52) U.S. Cl. 239/589

(57) ABSTRACT

A water-saving shower head [1000] for receiving a water stream from a water source [3] and spraying the water stream having a main body [1200] with an air inlet [1213] for receiving air and mixing it with the water stream to reduce water usage. The main body [1200] has an internal restrictor piece [1500] having a restrictor hole [1501] for restricting the flow of said water stream. The restrictor piece fits within the widened section [1209] of the main body [1200] and is allowed to flex and vibrate, thereby removing solutes attached to the restrictor piece [1500]. This results in a water-saving, low maintenance shower head that provides reduced energy consumption due to reduced hot water usage.

### FEDERAL SPONSORED RESEARCH

Not Applicable

### SEQUENCE LISTING OR PROGRAM

Not Applicable

### CROSS REFERENCE TO RELATED APPLICATIONS

Not Applicable.

### BACKGROUND OF THE INVENTION

1. Field of the Invention

The present invention relates to a device for saving water and more specifically for a device for saving water which is resistant to blockage.

2. Discussion of Related Art

Water and energy are increasingly valuable commodities. Due to the increases in energy costs, it is necessary to conserve energy.

Also, in the future, it is predicted that clean water will become less abundant and the costs to obtain and purify water will become increasingly costly.

Since millions of people are using hot water showers every day, there can be a huge savings of water and energy by having a more efficient shower.

Also, please note that standard showers also tend to build up deposits from dissolved substances in the water, such as minerals, precipitates out of the water and attaches to the shower outlet. This causes uneven shower spray and sometimes blockage, restricting spray of the hot water. It also causes increased energy costs and increased maintenance costs associated with cleaning and/or replacement of clogged or worn showerheads.

Currently, there is a need for a shower head which reduces the amount of hot water used, and also is resistant to the buildup of deposits and absorbs un-regulated water pressure prior to entering the showerhead.

### SUMMARY OF THE INVENTION

One embodiment of the present invention is a water-saving shower head [1000] for receiving a water stream from a water source [3] and spraying the water stream, the shower head [1000] comprising:
a) a connection end [1703] for connecting to said water source [3]:
b) a main body [1200] coupled to the connection end [1100], the main body [1200] having an air inlet [1213] for receiving air and mixing it with the water stream to reduce water usage, the main body [1200] also having a widened section [1209],
c) an internal restrictor piece [1500] having a restrictor hole [1501] for restricting the flow of said water stream, fitting within the widened section [1209] of the main body [1200],
d) a nozzle [1100] coupled to the main body [1200], the nozzle having a nozzle opening [1101] for releasing said water stream from the main body.

It may also be embodied as a water spraying device [1000] for retrofitting an existing water stream form a water source [3], the water spraying device [1000] comprising:
a) a connection end [1700] for connecting to said water source [3]:
b) a main body [1200] coupled to the connection end [1700], the main body [1200] having an air inlet [1213] for receiving air and mixing it with the water stream to reduce water usage, the main body [1200] also having a widened section [1209],
c) an internal restrictor piece [1500] having a restrictor hole [1501] for restricting the flow of said water stream, fitting within the widened section [1209] of the main body [1200],
d) a nozzle [1100] coupled to the main body [1200], the nozzle having a nozzle opening [1101] for releasing said water stream from the main body.

### OBJECTS OF THE INVENTION

It is an object of the present invention to provide a shower spray that introduces air to displace a controlled percentage of water, to result in reduced water volume used.

It is another object of the present invention to provide a shower head which reduces the amount energy used during a shower.

It is another object of the present invention to provide a device which sprays hot water which is resistant to the buildup of deposits.

It is another object of the present invention to provide an even shower spray over a long period of time.

It is another object of the present invention to provide a shower head which requires less maintenance.

### BRIEF DESCRIPTION OF THE DRAWINGS

The advantages of the instant disclosure will become more apparent when read with the specification and the drawings, wherein:

FIG. 1 is a perspective view of one embodiment of the shower head 1000 according to the present invention.

FIG. 2 is a partial cut-away perspective view of the shower head 1000 of FIG. 1.

FIG. 3 is a cut-away side elevational view of the shower head 1000 of FIG. 1.

### DETAILED DESCRIPTION OF THE INVENTION

Theory

Water Waste

It was determined that one may use less water to receive the same cleansing and aesthetic effects (“results”) from a shower. It appears that the water is dispersed when it impinges on the user has an effect on the results of the shower. For example, a shower having a large flow rate which has only a few streams, does not sufficiently cover the user's body effectively. Therefore, the user must spend extra time (and water) moving the shower head to more effectively cover the unwashed portions.

One such way to more efficiently use the water is to have many fine streams. This introduces problems of how to cause each nozzle hole to spray a similar amount of water as well as clogging, which will be discussed below.

Energy Waste

Since the water used has been heated, the more hot water used the more heat that is used. Therefore, by using excess water, excess energy is also used at the same rate.

Dissolved Solutes—Minerals

Tap water typically has dissolved solutes, such as minerals. These solutes come out of solution under certain conditions. Many materialize as free-floating objects which are passed out of the system.

Buildup

Others attach to another object, such as a shower head passageway as a deposit. Calcium and other commonly occurring minerals create a strong attachment to metal. These deposits grow over time and may clog or block passageways of a shower head. Usually, the smallest passageway is the first to block. The blockage causes uneven flow of the water, and uneven dispersion of the water spray. This causes additional water and energy to be used.

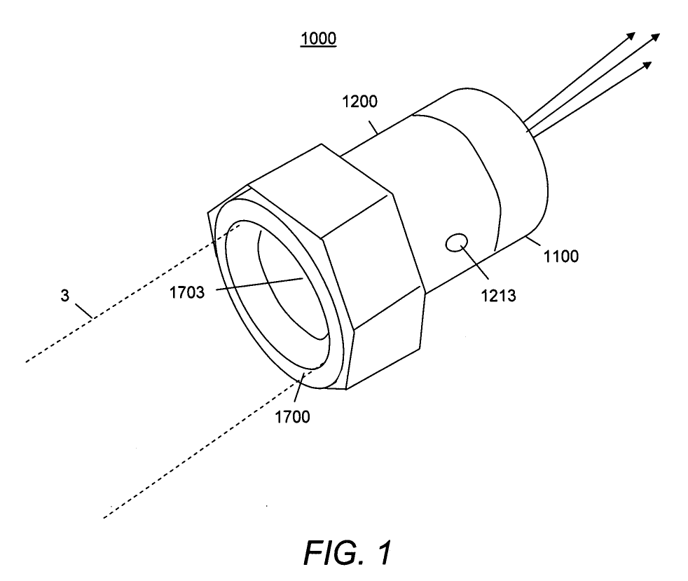

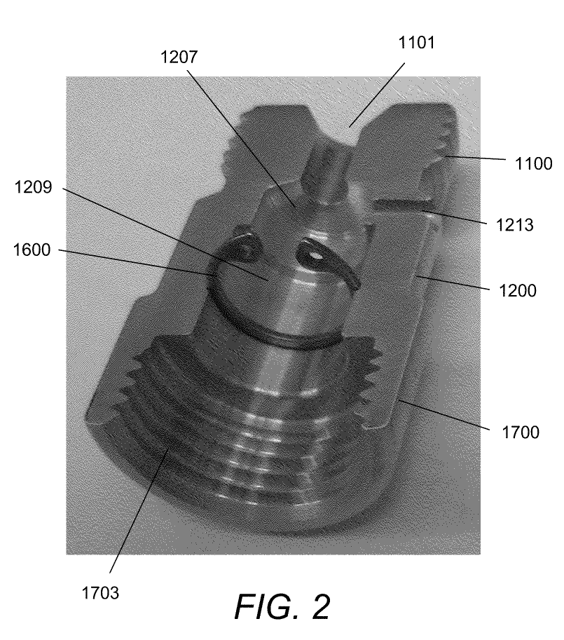

The present invention may be described in connection with FIGS. 1 and 2.

FIG. 1 is a perspective view of one embodiment of the shower head 1000 according to the present invention.

A connector section 1700 connects a main body 1200 of shower head 1000 to a water source 3 which is typically a household water pipe. Connector section 1100 typically is cylinder-shaped which connects to water source 3. These act to make a water-tight fit between the main body 1200 and the water source 3.

Water from the water source 3 passes through the main body 1200.

The distal end of the main body 1200 is attached to a nozzle 1700. Nozzle 1700 has an opening 1703. The main body 1200 is fluidically connected to nozzle section 1700 such that water passing through main body 1200 passes out of nozzle opening 1101.

As the water passes through the shower head 1000, air is drawn in through an air inlet 1213. This reduces the amount of water required.

FIG. 2 is a cut-away perspective view of the shower head 1000 of FIG. 1.

Connector section 1700 has an internal threaded section 1703 which screws into water source (not shown here). These act to make a water-tight fit between the main body 1200 and the water source 3.

Main body 1200 has an internal passageway 1207. Water from the water source 3 passes through the main body 1200

The internal passageway 1207 of the main body includes a widened section 1209. This widened section is designed to receive a disk not shown. The disk is held in place by a “c” clip 1600 which partially fits within a notch 1203 encircling the widened section 1209.

Internal passageway 1207 includes air inlet 1213. As water rushes through the internal passageway 1207 and past the air inlet 1213, air is sucked into the internal passageway by the ‘Venturi Effect’. The rapid intake of air and the rushing water cause them to mix into an air-water suspension of increased volume.

This air-water suspension is then sprayed out of nozzle opening 1101 onto the user. Since there is now a smaller amount of water being sprayed in the air-water suspension, there is a net savings of water and energy. It is believed that by adjusting the air inlet 1213 and the internal disk diameter (not shown), it is believed that there can be up to a 60% savings of water and energy using the present invention over conventional shower heads.

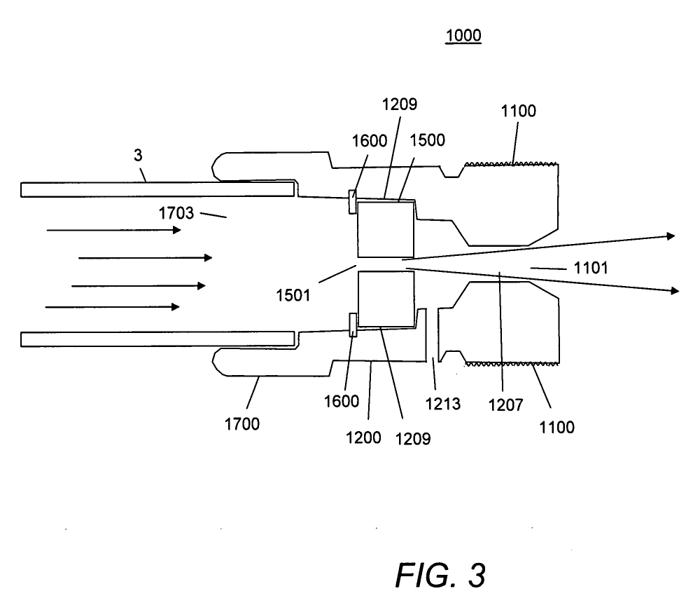

FIG. 3 is a cut-away side elevational view of the shower head 1000 of FIG. 1.

Here, the parts of FIG. 2 are shown here along with disk 1500. Disk 1500 employs a restrictor hole 1501 of a predetermined size which passes through it. Restrictor hole 1501 is typically has a smaller than any other portion of the internal passageway 1207.

The restrictor hole 1501 is sized to create the proper flow of water. The size of restrictor hole 1501 is selected based upon the size of air hole 1213 and average water flow from the water source 3.

Therefore, the present invention allows one to replace the disk 1500 with the proper sized restrictor hole 1501 to create the desired mixture of air to water. This design allows one to replace the disk 1500 to select the desired amount of water savings.

Disk 1500 is preferably constructed from a polymer, such as polyethylene, polypropylene, tetrofluoro ethylene (Teflon®), polyoxymethylene or other polymer which resists attachment of water soluble materials.

Preferably, disk 1500 is created from Teflon. In an alternative embodiment, it may be coated with Teflon. This material has both a very smooth surface and exhibits more flexibility than metal or many mineral deposits.

Disk 1500 is designed to fit inside of widened section 1209 of internal passageway 1207. It slides up against a proximal ridge 1215. One such attachment means is a “c” clip 1600 that fits into a notch 1203. C clip then fits against the outer side of disk 1500 to secure it. Disk 1500 is allowed to move slightly. The restrictor hole 1501 is designed to be the narrowest point through which the water passes. Deposits build up and clog water flow devices at the narrowest point.

The smooth surface of disk 1500 prevents most deposits from attaching to disk 1500 and restrictor hole 1501.

As water passes through internal passageway 1209 and through restrictor hole 1501, to causes disk 1500 to vibrate. The rapid vibratory motion of disk 1500 tends to throw off any deposits, preventing them from attaching to disk 1500.

Also, the motion and vibration of disk 1500 cause slight flexing of disk 1500. Most deposits are brittle. Therefore, as disk 1500 flexes, it causes micro fractures of the deposits. Therefore, the deposits fracture and are released from the disk 1500.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A water-saving shower head [1000] for receiving a water stream from a water source [3] and spraying the water stream, the shower head [1000] comprising:
a) a connection end [1703] for connecting to said water source [3]:
b) a main body [1200] coupled to the connection end [1100], the main body [1200] having an air inlet [1213] for receiving air and mixing it with the water stream to reduce water usage, the main body [1200] also having a widened section [1209],
c) an internal restrictor piece [1500] having a restrictor hole [1501] for restricting the flow of said water stream, fitting within the widened section [1209] of the main body [1200],
d) a nozzle [1100] coupled to the main body [1200], the nozzle having a nozzle opening [1101] for releasing said water stream from the main body.

2. The water-saving shower head [1000] of claim 1, wherein the restrictor piece [1500] is a disk constructed of a flexible material.

3. The water-saving shower head [1000] of claim 1 wherein the restrictor piece [1500] is made of polyoxymethylene.

4. The water-saving shower head [1000] of claim 1 further comprising an air inlet allowing ambient air to be mixed with said water stream reducing the amount of water used.

5. The water-saving shower head [1000] of claim 1 wherein the restrictor hole [1501] of restrictor piece [1500] is sized to allow a maximum flow of 1.5 gallons per minute of said water stream.

6. The water-saving shower head [1000] of claim 1 wherein the restrictor piece [1500] is removable allowing one to use a restrictor piece of a different size to select the desired amount of flow of said water stream.

7. A reduced maintenance shower head [1000] for receiving a water stream from a water source [3], the shower head [1000] comprising:
a) a connection end [1700] for connecting to said water source [3]:
b) a main body [1200] coupled to the connection end [1100], the main body [1200] having an air inlet [1213] for receiving air and mixing it with the water stream to reduce water usage, the main body [1200] also having a widened section [1209],
c) an internal restrictor piece [1500] having a restrictor hole [1501] for restricting the flow of said water stream, fitting within the widened section [1209] of the main body [1200],
d) a nozzle [1100] coupled to the main body [1200], the nozzle having a nozzle opening [1101] for releasing said water stream from the main body.

8. The water-saving shower head [1000] of claim 7 further comprising an air inlet allowing ambient air to be mixed with said water stream reducing the amount of water used.

9. The reduced maintenance shower head [1000] of claim 7, wherein the restrictor piece [1500] is a self cleaning piece.

10. The reduced maintenance shower head [1000] of claim 7, wherein the restrictor piece [1500] is constructed of a material which resists the buildup of solutes.

11. The reduced maintenance shower head [1000] of claim 7, wherein the restrictor piece [1500] is slightly smaller than the widened section [1209] and allowed to vibrate within the widened section [1209] thereby removing solutes attached to the restrictor piece [1500].

12. A water spraying device [1000] for retrofitting an existing water stream form a water source [3], the water spraying device [1000] comprising:
a) a connection end [1700] for connecting to said water source [3]:
b) a main body [1200] coupled to the connection end [1700], the main body [1200] having an air inlet [1213] for receiving air and mixing it with the water stream to reduce water usage, the main body [1200] also having a widened section [1209],
c) an internal restrictor piece [1500] having a restrictor hole [1501] for restricting the flow of said water stream, fitting within the widened section [1209] of the main body [1200],
d) a nozzle [1100] coupled to the main body [1200], the nozzle having a nozzle opening [1101] for releasing said water stream from the main body.

13. The water-saving shower head [1000] of claim 12, wherein the restrictor piece [1500] is a disk constructed of a flexible material.

14. The water-saving shower head [1000] of claim 12 wherein the restrictor piece [1500] is made of polyoxymethylene.

15. The water-saving shower head [1000] of claim 12 further comprising an air inlet allowing ambient air to be mixed with said water stream reducing the amount of water used.

16. The water-saving shower head [1000] of claim 12 wherein the restrictor hole [1501] of restrictor piece [1500] is sized to allow a maximum flow of 1.5 gallons per minute of said water stream.

17. The water-saving shower head [1000] of claim 12 wherein the restrictor piece [1500] is removable allowing one to use a restrictor piece of a different size to select the desired amount of flow of said water stream.
